(19) United States
(12) Patent Application Publication
(10) Pub. No.: US 2020/0267297 A1
(43) Pub. Date: Aug. 20, 2020

(54) IMAGE PROCESSING METHOD AND APPARATUS

(71) Applicant: SZ DJI TECHNOLOGY CO., LTD., Shenzhen (CN)

(72) Inventors: Qingbo LU, Shenzhen (CN); Chen LI, Shenzhen (CN)

(21) Appl. No.: 16/865,786

(22) Filed: May 4, 2020

Related U.S. Application Data
(63) Continuation of application No. PCT/CN2017/113244, filed on Nov. 28, 2017.

(51) Int. Cl. H04N 5/232; G06T 7/80

(52) U.S. Cl. CPC H04N 5/2327; H04N 5/23267; G06T 7/80

(57) ABSTRACT

An image processing method includes obtaining two-dimensional coordinate points of an input image, and according to a camera imaging model or a distortion correction model, performing a two-dimension to three-dimension conversion operation on the two-dimensional coordinate points to obtain a first processing result. The method also includes performing at least one of virtual reality processing or electronic image stabilization on the first processing result to obtain a second processing result, and mapping the second processing result to a two-dimensional image coordinate system to obtain an output image.

### CROSS-REFERENCE TO RELATED APPLICATION

This application is a continuation of International Application No. PCT/CN2017/113244, filed on Nov. 28, 2017, the entire content of which is incorporated herein by reference.

### TECHNICAL FIELD

The present disclosure relates to image processing technologies and, more particularly, to an image processing method and an image processing apparatus.

### BACKGROUND

During an imaging process, an image sensor may record light incident on the image sensor. Since some camera components, such as a lens, an image sensor, etc., may have certain distortion or alignment problems, a camera may not conform to a common camera-imaging model. Generally, a camera with a larger angle of view (AOV) may have more severe distortion. A lens with a large AOV may provide a large field of view, and is often used in collecting virtual-reality images. When a lens with a large AOV is installed in environments such as sports equipment, cars, unmanned aerial vehicles, etc., due to vibrations of a camera, images recorded by the camera may frequently shake, causing discomfort to an observer. In this case, at least two operations of electronic image stabilization, distortion correction, and virtual reality processing need to be performed simultaneously on input images.

However, during a process of simultaneously performing at least two operations of electronic image stabilization, distortion correction, or virtual reality processing, performing any one of the operations needs to calculate geometric transformation relationships between an input image and an output image. That is, coordinate relationships between the output image and the input image need to be calculated. As such, processing an input image may have high calculation complexity, and may take a long calculation time.

The disclosed methods and apparatus are directed to solve one or more problems set forth above and other problems in the art.

### SUMMARY

One aspect of the present disclosure includes an image processing method. The image processing method includes obtaining two-dimensional coordinate points of an input image, and according to a camera imaging model or a distortion correction model, performing a two-dimension to three-dimension conversion operation on the two-dimensional coordinate points to obtain a first processing result. The method also includes performing at least one of virtual reality processing or electronic image stabilization on the first processing result to obtain a second processing result, and mapping the second processing result to a two-dimensional image coordinate system to obtain an output image.

Another aspect of the present disclosure includes an image processing apparatus. The image processing apparatus includes a lens, an image sensor, and a processor. The image sensor acquires a two-dimensional image through the lens, and the two-dimensional image is used as an input image. The processor is configured to perform obtaining two-dimensional coordinate points of the input image, performing a two-dimension to three-dimension conversion operation on the two-dimensional coordinate points, according to a camera imaging model or a distortion correction model, to obtain a first processing result, performing at least one of virtual reality processing or electronic image stabilization on the first processing result to obtain a second processing result, and mapping the second processing result to a two-dimensional image coordinate system to obtain an output image.

Another aspect of the present disclosure includes a non-transitory computer-readable storage medium containing computer-executable instructions for, when executed by one or more processors, performing an image processing method. The image processing method includes obtaining two-dimensional coordinate points of an input image, and according to a camera imaging model or a distortion correction model, performing a two-dimension to three-dimension conversion operation on the two-dimensional coordinate points to obtain a first processing result. The method also includes performing at least one of virtual reality processing or electronic image stabilization on the first processing result to obtain a second processing result, and mapping the second processing result to a two-dimensional image coordinate system to obtain an output image.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a schematic diagram of an exemplary application scenario consistent with the disclosed embodiments of the present disclosure;

FIG. 2 illustrates a flowchart of an exemplary image processing method consistent with the disclosed embodiments of the present disclosure;

FIG. 3 illustrates a flowchart of another exemplary image processing method consistent with the disclosed embodiments of the present disclosure;

FIG. 4 illustrates a schematic diagram of the flowchart shown in FIG. 3, consistent with the disclosed embodiments of the present disclosure;

FIG. 5 illustrates a flowchart of another exemplary image processing method consistent with the disclosed embodiments of the present disclosure;

FIG. 6 illustrates a schematic diagram of the flowchart shown in FIG. 5, consistent with the disclosed embodiments of the present disclosure;

FIG. 7 illustrates a flowchart of another exemplary image processing method consistent with the disclosed embodiments of the present disclosure;

FIG. 8 illustrates a schematic diagram of the flowchart shown in FIG. 7, consistent with the disclosed embodiments of the present disclosure;

FIG. 9 illustrates a flowchart of another exemplary image processing method consistent with the disclosed embodiments of the present disclosure;

FIG. 10 illustrates a schematic diagram of the flowchart shown in FIG. 9, consistent with the disclosed embodiments of the present disclosure; and

FIG. 11 illustrates a structural diagram of an exemplary image processing apparatus consistent with the disclosed embodiments of the present disclosure.

### DETAILED DESCRIPTION OF THE EMBODIMENTS

To make the objectives, technical solutions and advantages of the present invention clearer and more explicit, the present invention is described in further detail with accompanying drawings. It should be understood that specific exemplary embodiments described herein are only for explaining the present invention and are not intended to limit the present invention.

Reference will now be made in detail to exemplary embodiments of the present disclosure, which are illustrated in the accompanying drawings. Wherever possible, the same reference numbers will be used throughout the drawings to refer to the same or like parts.

It should be noted that relative arrangements of components and steps, numerical expressions and numerical values set forth in exemplary embodiments are for illustration purpose only and are not intended to limit the present disclosure unless otherwise specified. Techniques, methods and apparatus known to the skilled in the relevant art may not be discussed in detail, but these techniques, methods and apparatus should be considered as a part of the specification, where appropriate.

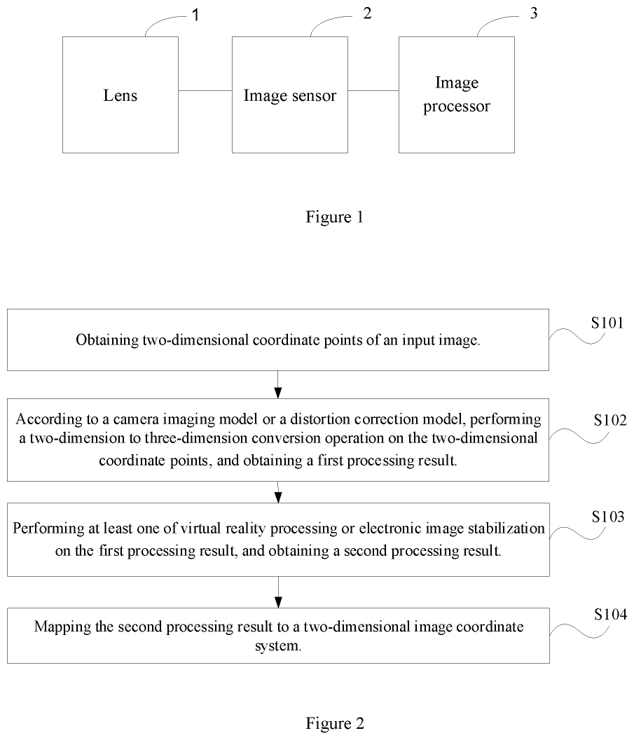

FIG. 1 illustrates a schematic diagram of an exemplary application scenario consistent with the disclosed embodiments of the present disclosure. As shown in FIG. 1, the application scenario includes an image processing apparatus. The image processing apparatus may be a camera, a video recording device, an aerial photography device, a medical imaging device, and the like.

The image processing apparatus may include a lens 1, an image sensor 2, and an image processor 3. The lens 1 is connected to the image sensor 2, and the image sensor 2 is connected to the image processor 3. Light may enter the image sensor 2 through the lens 1, and the image sensor 2 may perform an imaging function, and thus an input image may be obtained. The image processor 3 may perform at least two operations of distortion correction, electronic image stabilization, or virtual reality processing, on the input image, and thus an output image may be obtained.

An image processing method provided by the present disclosure may reduce calculation complexity, shorten calculation time, and improve image processing efficiency of the image processor during a period of performing at least two processing operations of distortion correction, electronic image stabilization, or virtual reality.

It should be noted that, in the present disclosure, the image processor 3 and the lens 1 and the image sensor 3 may be located on different electronic devices or on a same electronic device.

FIG. 2 illustrates a flowchart of an exemplary image processing method consistent with the disclosed embodiments of the present disclosure. As shown in FIG. 2, the image processing method may include followings.

S101: obtaining two-dimensional coordinate points of an input image. Specifically, when light enters an image sensor through a lens, the image sensor may perform an imaging function and thus an input image may be obtained. Since the input image is a two-dimensional image, two-dimensional coordinate points of all pixel points of the input image may be obtained.

S102: according to a camera imaging model or a distortion correction model, performing a two-dimension to three-dimension conversion operation on the two-dimensional coordinate points, and obtaining a first processing result.

Specifically, performing the two-dimension to three-dimension conversion operation refers to establishing one-to-one correspondence between the two-dimensional coordinate points and incident rays. The two-dimensional coordinate points of all pixel points of the input image may be mapped as incident rays, and the first processing result refers to the incident rays corresponding to the two-dimensional coordinate points of all the pixel points of the input image.

In one embodiment, S102 may include, according to camera parameters and the camera imaging model, performing the two-dimension to three-dimension conversion operation on the two-dimensional coordinate points, and obtaining the first processing result. In some other embodiments, S102 may include, according to the camera parameters and the distortion correction model, performing the two-dimension to three-dimension conversion operation on the two-dimensional coordinate points, and obtaining the first processing result.

The camera parameters may include a focal length of the camera and an optical-center position of the camera, etc. The camera imaging model may include one of a pinhole imaging model, an isometric rectangular model, a stereo imaging model, a fisheye lens model, or a wide-angle lens model. The camera imaging model may be set according to actual requirements.

S103: performing at least one of virtual reality processing or electronic image stabilization on the first processing result, and obtaining a second processing result. The virtual reality processing may refer to producing a computer simulated environment that may simulate a physical presence in places in the real world or imagined worlds. The electronic image stabilization may refer to an image enhancement technique using electronic processing, and may minimize blurring and compensate for device shake. The virtual reality processing may be performed on the first processing result according to a first rotation matrix, and the electronic image stabilization may be performed on the first processing result according to a second rotation matrix. The second processing result may be obtained by processing the first processing result obtained in S102, according to at least one of the first rotation matrix or the second rotation matrix.

Specifically, the first rotation matrix may be determined according to an attitude-angle parameter of an observer, and the second rotation matrix may be determined according to a measurement parameter obtained from an inertial measurement unit connected to a camera. The camera may specifically refer to the lens and the image sensor shown in FIG. 1.

S104: mapping the second processing result to a two-dimensional image coordinate system. Specifically, an output image may be obtained by mapping each adjusted incident ray to the two-dimensional image coordinate system. The output image is an image after undergoing at least two operations of distortion correction, electronic image stabilization, or virtual reality processing.

In one embodiment, the first processing result is obtained by performing a two-dimension to three-dimension conversion operation on the two-dimensional coordinate points of an input image obtained. The first processing result is processed according to at least one of a first rotation matrix or a second rotation matrix, and a second processing result may thus be obtained. The second processing result is mapped to a two-dimensional image coordinate system, and an output image may thus be obtained. Accordingly, fast processing of the input image may be realized, such that at least two operations of distortion correction, electronic image stabilization, or virtual reality processing may be completed. This processing method may reduce calculation complexity, shorten calculation time, and improve image processing efficiency. For the camera imaging model, the distortion correction model, the first rotation matrix, and the second rotation matrix involved in the present disclosure, reference may be made to existing technologies.

Technical solutions of the image processing method provided by the present disclosure are described in detail with following embodiments.

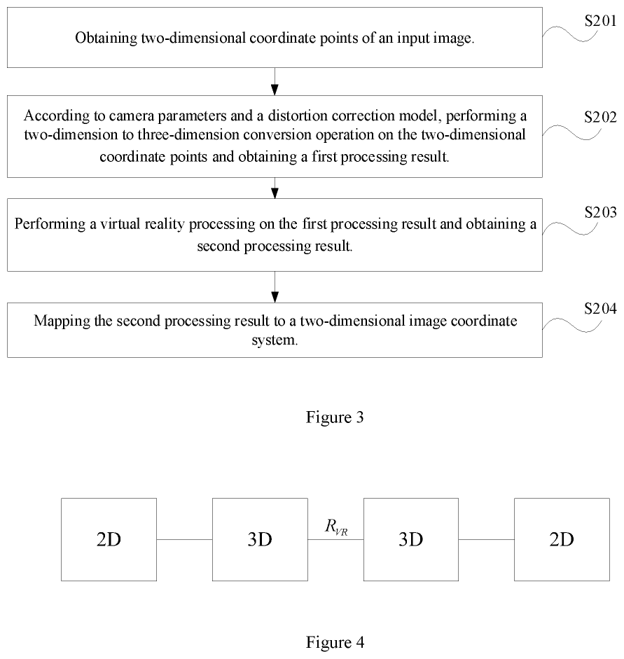

FIG. 3 illustrates a flowchart of another exemplary image processing method consistent with the disclosed embodiments of the present disclosure. FIG. 4 illustrates a schematic diagram of the flowchart shown in FIG. 3. In one embodiment, the input image is processed by performing distortion correction and virtual reality processing. As shown in FIG. 3, the image processing method may include followings.

S201: obtaining two-dimensional coordinate points of an input image. For a specific explanation of S201, reference may be made to S101 in the embodiment shown in FIG. 2, and details are not described here again.

S202: according to camera parameters and a distortion correction model, performing a two-dimension to three-dimension conversion operation on the two-dimensional coordinate points and obtaining a first processing result.

S202 may realize a conversion from 2D to 3D shown in FIG. 4. With P_{3D} denoting the first processing result and P_{2D} denoting the two-dimensional coordinate points, S202 may be, according to a formula P_{3D}=ƒₚᵢₙ(P_{2D}), obtaining the first processing result P_{3D}, where a function ƒₚᵢₙ( ) may be a polynomial.

S203: performing a virtual reality processing on the first processing result and obtaining a second processing result. Specifically, the first rotation matrix is a rotation matrix used in a virtual reality processing, and may be determined according to an attitude-angle parameter of an observer. In S203, a 3D to 3D rotation processing shown in FIG. 4 may be implemented, and the second processing result may be obtained.

Specifically, with P′_{3D} denoting the second processing result, and R_{VR} denoting the first rotation matrix, S203 may be, according to a formula P′_{3D}=R_{VR}P_{3D}, obtaining the second processing result P′_{3D}. By inserting the formula P_{3D}=ƒₚᵢₙ(P_{2D}) of S202 into the formula P′_{3D}=R_{VR}P_{3D}, a formula P′_{3D}′=R_{VR}ƒₚᵢₙ(P_{2D}) may be obtained.

S204: mapping the second processing result to a two-dimensional image coordinate system. Specifically, by mapping the incident rays after a rotation processing in S203 to the two-dimensional image coordinate system, an output image may be obtained. The output image is an image that has undergone the distortion correction and the virtual reality processing. S204 may realize a 3D to 2D mapping shown in FIG. 4.

Specifically, with P′_{2D} denoting coordinate points mapped to the two-dimensional image coordinate system, S204 may be, according to a formula P′_{2D}=ƒ_{cam}⁻¹(P′_{3D}), mapping the second processing result to the two-dimensional image coordinate system. A function ƒ_{cam}⁻¹( ) may be set according to actual requirements. By inserting the formula P′_{3D}=R_{VR}ƒₚᵢₙ(P_{2D}) of S203 into the formula P′_{2D}=ƒ_{cam}⁻¹(P′_{3D}), a formula P′_{2D}=ƒ_{cam}⁻¹(R_{VR}ƒₚᵢₙ(P_{2D})) may be obtained.

In one embodiment, according to the camera parameters and the distortion correction model, the first processing result may be obtained by performing the two-dimension to three-dimension conversion operation on the two-dimensional coordinate points of the input image obtained. The second possessing result may be obtained by performing the virtual reality processing on the first processing result. The output image may be obtained by mapping the second processing result to the two-dimensional image coordinate system. Accordingly, fast processing of the input image may be realized, such that the distortion correction and the virtual reality processing may be completed. As such, calculation complexity may be reduced, calculation time may be shortened, and image processing efficiency may be improved.

In addition, in the present disclosure, since the distortion correction and virtual reality processing are completed in a way described above, operations P_{2D}=ƒ_{cam}⁻¹(P_{3D}) and P_{3D}=ƒ_{cam}(P_{2D}) are not required to be performed before P′_{3D}=R_{VR}P_{3D} and after formula P_{3D}=ƒₚᵢₙ(P_{2D}). Thus, calculation may be simplified. In addition, since calculations of P_{2D}=ƒ_{cam}⁻¹ and P_{3D}=ƒ_{cam}(P_{2D}) are usually performed through fixed-pointing or looking-up tables, P_{2D}=ƒ_{cam}⁻¹(P_{3D}) and P_{3D}=ƒ_{cam}(P_{2D}) may not be completely equivalent inverse operations. After repeated calculations, cumulative errors may increase. Accordingly, by simplifying the calculation in a manner described above, the cumulative errors may be eliminated, and calculation accuracy may be improved.

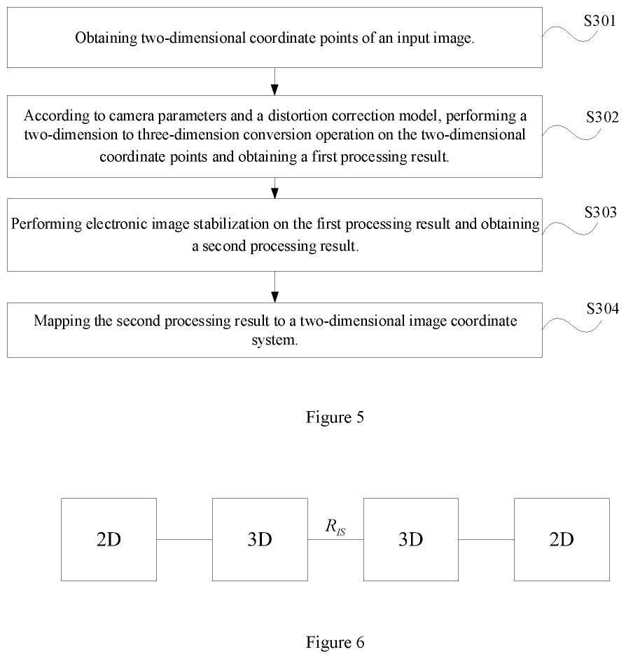

FIG. 5 illustrates a flowchart of another exemplary image processing method consistent with the disclosed embodiments of the present disclosure. FIG. 6 illustrates a schematic diagram of the flowchart shown in FIG. 5. In one embodiment, the distortion correction and the electronic image stabilization are performed on an input image. As shown in FIG. 5, the image processing method may include followings.

S301: obtaining two-dimensional coordinate points of an input image. For a specific explanation of S301, reference may be made to S101 in the embodiment shown in FIG. 2, and details are not described here again.

S302: according to camera parameters and a distortion correction model, performing a two-dimension to three-dimension conversion operation on the two-dimensional coordinate points and obtaining a first processing result.

S302 may realize a conversion from 2D to 3D shown in FIG. 6. Specifically, according to the camera parameters and the distortion correction model, the two-dimension to three-dimension conversion operation may be performed on the two-dimensional coordinate points. That is, the two-dimensional coordinate points may be mapped as incident rays.

With P_{3D} denoting the first processing result and P_{2D} denoting the two-dimensional coordinate points, S302 may be, according to a formula P_{3D}=ƒₚᵢₙ(P_{2D}), obtaining the first processing result P_{3D}, where the function ƒₚᵢₙ( ) may be a polynomial.

S303: performing electronic image stabilization on the first processing result and obtaining a second processing result. A second rotation matrix is a rotation matrix used in the electronic image stabilization, and may be determined according to a measurement parameter obtained from an inertial measurement unit connected to the camera. S303 may realize a 3D to 3D rotation processing shown in FIG. 6. That is, the incident rays obtained in S302 may be rotated according to the second rotation matrix, and the second processing result may thus be obtained.

With P′_{3D} denoting the second processing result and R_{IS} denoting the second rotation matrix, S303 may be, according to a formula P′_{3D}=R_{IS}P_{3D}, obtaining the second processing result P′_{3D}. By inserting the formula P_{3D}=ƒₚᵢₙ(P_{2D}) of S302 into the formula P′_{3D}=R_{IS}P_{3D}, a formula P′_{3D}=R_{IS}ƒₚᵢₙ(P_{2D}) may be obtained.

S304: mapping the second processing result to a two-dimensional image coordinate system. Specifically, by mapping the incident rays after the rotation processing in S303 to the two-dimensional image coordinate system, an output image may be obtained. The output image is an image that has undergone the distortion correction and the electronic image stabilization. S304 may realize a 3D to 2D mapping shown in FIG. 6.

Specifically, with P′_{2D} denoting coordinate points mapped to the two-dimensional image coordinate system, S304 may be, according to a formula P′_{2D}=ƒ_{cam}⁻¹(P′_{3D}), mapping the second processing result to the two-dimensional image coordinate system. A function ƒ_{cam}⁻¹( ) may be set according to actual requirements. By inserting the formula P′_{3D}=R_{IS}ƒₚᵢₙ(P_{2D}) of S303 into the formula P′_{2D}=ƒ_{cam}⁻¹(P′_{3D}), a formula P′_{2D}=ƒ_{cam}⁻¹(R_{IS}ƒₚᵢₙ(P_{2D})) may be obtained.

In one embodiment, according to the camera parameters and the distortion correction model, the first processing result may be obtained by performing the two-dimension to three-dimension conversion operation on the two-dimensional coordinate points of the input image obtained. The second possessing result may be obtained by performing the electronic image stabilization on the first processing result. The output image may be obtained by mapping the second processing result to the two-dimensional image coordinate system. Accordingly, fast processing of the input image may be realized, such that the distortion correction and electronic image stabilization may be completed. As such, calculation complexity may be reduced, calculation time may be shortened, and image processing efficiency may be improved.

In addition, in the present disclosure, since the distortion correction and the electronic image stabilization are completed in a way described above, operations P_{2D}=ƒ_{cam}⁻¹(P_{3D}) and P_{3D}=ƒ_{cam}(P_{2D}) are not required to be performed before P′_{3D}=R_{IS}P_{3D} and after P_{3D}=ƒₚᵢₙ(P_{2D}). Thus, calculation may be simplified. In addition, since calculations of P_{2D}=ƒ_{cam}⁻¹(P_{3D}) and P_{3D}=ƒ_{cam}(P_{2D}) are usually performed through fixed-pointing or looking-up tables, P_{2D}=ƒ_{cam}⁻¹(P_{3D}) and P_{3D}=ƒ_{cam}(P_{2D}) may not be completely equivalent inverse operations. After repeated calculations, cumulative errors may increase. Accordingly, by simplifying the calculation in the manner described above, the cumulative errors may be eliminated, and calculation accuracy may be improved.

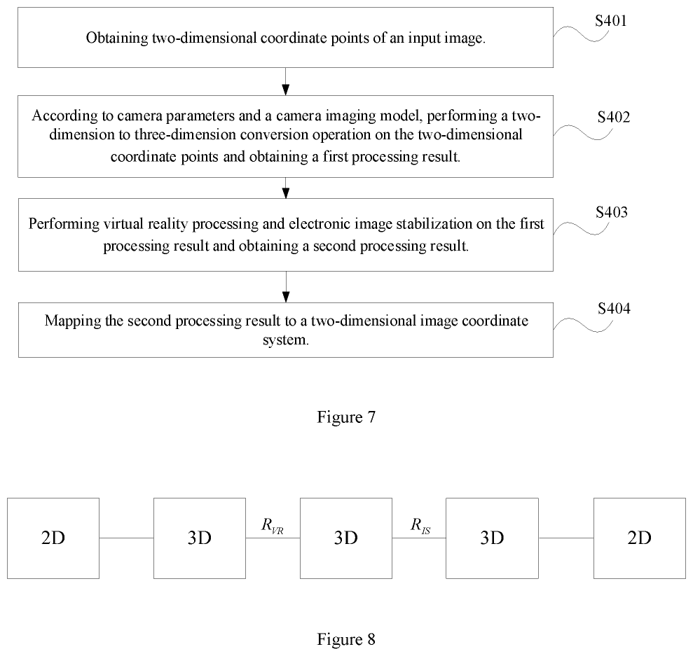

FIG. 7 illustrates a flowchart of another exemplary image processing method consistent with the disclosed embodiments of the present disclosure. FIG. 8 illustrates a schematic diagram of the flowchart shown in FIG. 7. In one embodiment, the virtual reality processing and electronic image stabilization are performed on the input image. As shown in FIG. 7, the image processing method may include followings.

S401: obtaining two-dimensional coordinate points of an input image. For a specific explanation of S401, reference may be made to S101 in the embodiment shown in FIG. 2, and details are not described here again.

S402: according to camera parameters and a camera imaging model, performing a two-dimension to three-dimension conversion operation on the two-dimensional coordinate points and obtaining a first processing result.

S402 may realize a conversion from 2D to 3D as shown in FIG. 8. Specifically, according to the camera parameters and the distortion correction model, the two-dimension to three-dimension conversion operation may be performed on the two-dimensional coordinate points. That is, the two-dimensional coordinate points may be mapped as incident rays.

With P_{3D} denoting the first processing result, and P_{2D} denoting the two-dimensional coordinate points, S402 may be, according to a formula P_{3D}=ƒ_{cam}(P_{2D}), obtaining the first processing result P_{3D}.

S403: performing virtual reality processing and electronic image stabilization on the first processing result and obtaining a second processing result.

Specially, a first rotation matrix is a rotation matrix used in the virtual reality processing, and may be determined according to an attitude-angle parameter of an observer. A second rotation matrix is a rotation matrix used in the electronic image stabilization, and may be determined according to a measurement parameter obtained from an inertial measurement unit connected to the camera. S403 may realize a 3D to 3D to 3D rotation processing shown in FIG. 8. That is, the incident rays obtained in S402 may be rotated according to the first rotation matrix and the second rotation matrix, and the second processing result may thus be obtained.

With P_{3D} denoting the second processing result, R_{VR} denoting the first rotation matrix, and R_{IS} denoting the second rotation matrix, S403 may be, according to a formula P′_{3D}=R_{IS}R_{VR}P_{3D}, obtaining the second processing result P_{3D}. That is, the virtual reality processing is performed first, and then the electronic image stabilization is performed. By inserting the formula of S402 into formula P_{3D}=R_{IS}R_{VR}P_{3D}, a formula P′_{3D}=R_{IS}R_{VR}ƒ_{cam}(P_{2D}) may be obtained.

It should be noted that, S403 may also be, according to a formula P′_{3D}=R_{VR}R_{IS}P_{3D}, obtaining the second processing result P′_{3D}. That is, the electronic image stabilization is performed first, and then the virtual reality processing is performed. By inserting the formula of S402 into the formula P′_{3D}=R_{VR}R_{IS}P_{3D}, a formula P′_{3D}=R_{VR}R_{IS}ƒ_{cam}(P_{2D}) may be obtained.

S404: mapping the second processing result to a two-dimensional image coordinate system. Specifically, by mapping the incident rays after the rotation processing of S403 to the two-dimensional image coordinate system, the output image may be obtained. The output image is an image that has undergone the virtual reality processing and the electronic image stabilization. S404 may realize a 3D to 2D mapping shown in FIG. 8.

Specifically, with P′_{2D} denoting coordinate points mapped on the two-dimensional image coordinate system, S404 may be, according to a formula P′_{2D}=ƒ_{cam}⁻¹(P′_{3D}), mapping the second processing result to the two-dimensional image coordinate system. A function ƒ_{cam}⁻¹( ) may be set according to actual requirements.

By inserting the formula P′_{3D}=R_{IS}R_{VR}ƒ_{cam}(P_{2D}) of S403 into the formula P′_{2D}=ƒ_{cam}⁻¹(P′_{3D}), a formula P′_{2D}=ƒ_{cam}⁻¹(R_{IS}R_{VR}ƒ_{cam}(P_{2D})) may be obtained. By inserting the formula P′_{3D}=R_{VR}R_{IS}ƒ_{cam}(P_{2D}) of S403 into the formula P′_{2D}=ƒ_{cam}⁻¹(P′_{3D}), a formula P′_{2D}=ƒ_{cam}⁻¹(R_{VR}R_{IS}ƒ_{cam}(P_{2D})) may be obtained.

In one embodiment, according to the camera parameters and the distortion correction model, the first processing result may be obtained by performing the two-dimension to three-dimension conversion operation on the two-dimensional coordinate points of the input image obtained. The second possessing result may be obtained by performing the virtual reality processing and the electronic image stabilization on the first processing result. The output image may be obtained by mapping the second processing result to the two-dimensional image coordinate system. Accordingly, fast processing of input images may be realized, such that the virtual reality processing and electronic image stabilization may be completed. As such, calculation complexity may be reduced, calculation time may be shortened, and image processing efficiency may be improved.

In addition, in the present disclosure, since the virtual reality processing and electronic image stabilization are completed in a way described above, operations P_{2D}=ƒ_{cam}⁻¹(P_{3D}) and P_{3D}=ƒ_{cam}(P_{2D}) are not required to be performed before P′_{3D}=R_{IS}R_{VR}P_{3D} (or P′_{3D}=R_{VR}R_{IS}P_{3D}) and after formula P_{3D}=ƒₚᵢₙ(P_{2D}) Thus, calculation may be simplified. In addition, since calculation of P_{2D}=ƒ_{cam}⁻¹(P_{3D}) and P_{3D}=ƒ_{cam}(P_{2D}) is usually performed through fixed-pointing or looking-up tables, P_{2D}=ƒ_{cam}⁻¹(P_{3D}) and P_{3D}=ƒ_{cam}(P_{2D}) may not be completely equivalent inverse operations. After repeated calculations, cumulative errors may increase. Accordingly, by simplifying the calculation in a manner described above, the cumulative errors may be eliminated, and calculation accuracy may be improved.

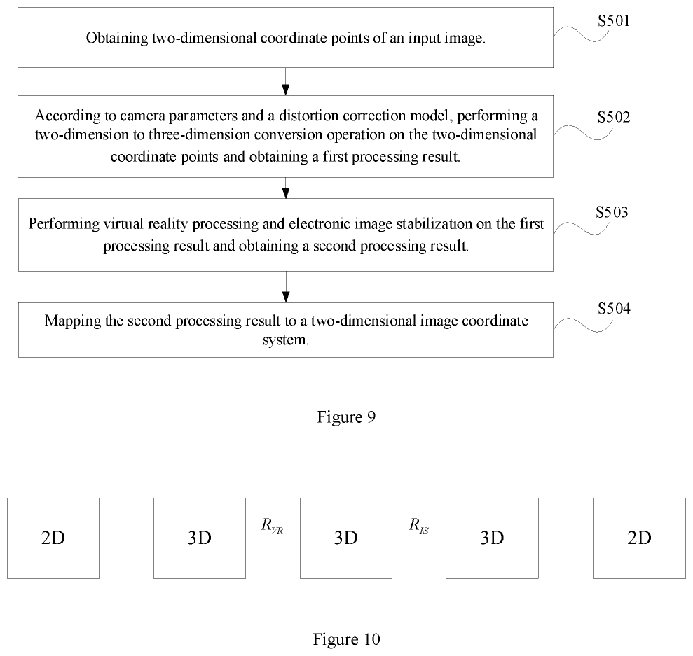

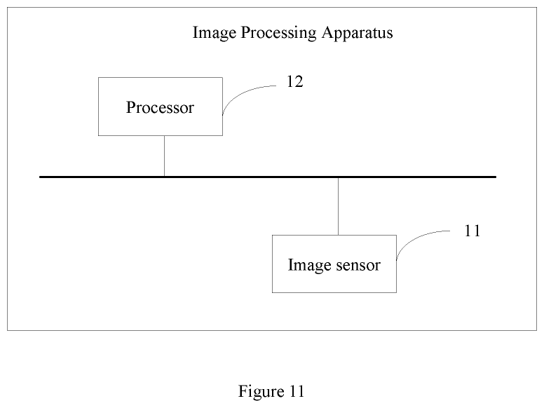

FIG. 9 illustrates a flowchart of another exemplary image processing method consistent with the disclosed embodiments of the present disclosure. FIG. 10 illustrates a schematic diagram of the flowchart shown in FIG. 9. In one embodiment, the distortion correction, the virtual reality processing and electronic image stabilization are performed on an input image. As shown in FIG. 9, the image processing method may include followings.

S501: obtaining two-dimensional coordinate points of an input image. For a specific explanation of S501, reference may be made to S101 in the embodiment shown in FIG. 2, and details are not described here again.

S502: according to camera parameters and a distortion correction model, performing a two-dimension to three-dimension conversion operation on the two-dimensional coordinate points and obtaining a first processing result.

S502 may realize a conversion from 2D to 3D as shown in FIG. 10. Specifically, according to the camera parameters and the distortion correction model, the two-dimension to three-dimension conversion operation may be performed on the two-dimensional coordinate points. That is, the two-dimensional coordinate points may be mapped as incident rays.

With P_{3D} denoting the first processing result and P_{2D} denoting the two-dimensional coordinate points, S502 may be, according to a formula P_{3D}=ƒₚᵢₙ(P_{2D}), obtaining the first processing result P_{3D}.

It should be noted that, unlike the embodiment shown in FIG. 7, the embodiment shown in FIG. 9 may perform three types of processing, including distortion correction, virtual reality processing, and electronic image stabilization. In a procedure of completing the three types of processing, the distortion correction needs to be performed in S502. The first processing result is P_{3D}=ƒₚᵢₙ(P_{2D}).

S503: performing virtual reality processing and electronic image stabilization on the first processing result and obtaining a second processing result.

The first rotation matrix is a rotation matrix used in the virtual reality processing, and may be determined according to an attitude-angle parameter of an observer. The second rotation matrix is a rotation matrix used in the electronic image stabilization, and may be determined according to a measurement parameter obtained from an inertial measurement unit connected to the camera. S503 may realize a 3D to 3D to 3D rotation processing shown in FIG. 10. That is, the incident rays obtained in S502 may be rotated according to the first rotation matrix and the second rotation matrix, and the second processing result may thus be obtained. That is, as shown in FIG. 10, the virtual reality processing is performed first and then the electronic image stabilization is performed.

In some other embodiments, in S503, electronic image stabilization may be performed first and then the virtual reality processing is performed.

With P′_{3D} denoting the second processing result, R_{VR} denoting the first rotation matrix, and R_{IS} denoting the second rotation matrix, S403 may be, according to a formula P′_{3D}=R_{IS}R_{VR}P_{3D}, obtaining the second processing result P′_{3D}. By inserting the formula of S502 into the formula P′_{3D}=R_{IS}R_{VR}P_{3D}, a formula P′_{3D}=R_{IS}R_{VR}ƒₚᵢₙ(P_{2D}) may be obtained.

It should be noted that, S503 may also be, according to a formula P′_{3D}=R_{VR}R_{Is}P_{3D}, obtaining the second processing result P′_{3D}. By inserting the formula of S502 into the formula P′_{3D}=R_{VR}R_{IS}P_{3D}, a formula P′_{3D}=R_{VR}R_{IS}ƒₚᵢₙ(P_{2D}) may be obtained.

S504: mapping the second processing result to a two-dimensional image coordinate system. Specifically, by mapping the incident rays after the rotation processing in S503 to the two-dimensional image coordinate system, the output image may be obtained. The output image is an image that has undergone the distortion correction, virtual reality processing and electronic image stabilization. S504 may realize a 3D to 2D mapping shown in FIG. 10.

With P′_{2D} denoting coordinate points mapped to the two-dimensional image coordinate system, S504 may be, according to a formula P′_{2D}=ƒ_{cam}⁻¹(P′_{3D}), mapping the second processing result to the two-dimensional image coordinate system. A function ƒ_{cam}⁻¹( ) may be set according to actual requirements.

By inserting the formula P′_{3D}=R_{IS}R_{VR}ƒₚᵢₙ, S503 into the formula P′_{2D}=ƒ_{cam}⁻¹(P′_{3D}), a formula P′_{2D}=ƒ_{cam}⁻¹(R_{IS}R_{VR}ƒₚᵢₙ(P_{2D})) may be obtained. By inserting the formula P′_{3D}=R_{VR}R_{IS}ƒₚᵢₙ(P_{2D}) of S503 into the formula P′_{2D}=ƒ_{cam}⁻¹(P′_{3D}), a formula P′_{2D}=ƒ_{cam}⁻¹(R_{VR}R_{IS}ƒₚᵢₙ(P_{2D})) may be obtained.

In one embodiment, according to the camera parameters and the distortion correction model, the first processing result may be obtained by performing the two-dimension to three-dimension conversion operation on the two-dimensional coordinate points of the input image obtained. The second possessing result may be obtained by performing the virtual reality processing and the electronic image stabilization on the first processing result. The output image may be obtained by mapping the second processing result to the two-dimensional image coordinate system. Accordingly, fast processing of input images may be realized, such that the distortion correction, virtual reality processing and electronic image stabilization may be completed. As such, calculation complexity may be reduced, calculation time may be shortened, and image processing efficiency may be improved.

In addition, in the present disclosure, since the distortion correction, virtual reality processing and electronic image stabilization are completed in a way described above, operations P_{2D}=ƒ_{cam}⁻¹(P_{3D}) and P_{3D}=ƒ_{cam}(P_{2D}) are not required to be performed before P′_{3D}=R_{IS}R_{VR}P_{3D} (or P′_{3D}=R_{VR}R_{IS}P_{3D}) and after P_{3D}=ƒ_{cam}(P_{2D}). Thus, calculation may be simplified. In addition, since calculations of P_{2D}=ƒ_{cam}⁻¹(P_{3D}) and P_{3D}=ƒ_{cam}(P_{2D}) are usually performed by fixed-pointing or looking-up tables, P_{2D}=ƒ_{cam}⁻(P_{3D}) and P_{3D}=ƒ_{cam}(P_{2D}) may not be completely equivalent inverse operations. After repeated calculations, cumulative errors may increase. Accordingly, by simplifying the calculation in a manner described above, the cumulative errors may be eliminated, and calculation accuracy may be improved.

FIG. 11 illustrates a structural diagram of an exemplary image processing apparatus consistent with the disclosed embodiments of the present disclosure. As shown in FIG. 11, the apparatus includes a lens (not shown), an image sensor 11 and a processor 12. The image sensor 11 may be used to acquire a two-dimensional image, and the two-dimensional image may be used as an input image. The processor 12 may be used to obtain two-dimensional coordinate points of the input image. The processor 12 may also perform a two-dimension to three-dimension conversion operation on the two-dimensional coordinate points according to a camera imaging model or a distortion correction model, and a first processing result may thus be obtained. The processor may further perform at least one of virtual reality processing or electronic image stabilization on the first processing result for obtaining a second processing result, and map the second processing result to a two-dimensional image coordinate system.

In one embodiment, the processor 12 is configured to perform a two-dimension to three-dimension conversion operation on the two-dimensional coordinate points according to camera parameters and a camera imaging model to obtain a first processing result. In some other embodiments, the processor 12 may be configured to perform a two-dimension to three-dimension conversion operation on the two-dimensional coordinate points according to camera parameters and a distortion correction model to obtain a first processing result.

The processor 12 may be configured to perform a virtual reality processing on the first processing result according to a first rotation matrix.

The processor 12 may be configured to perform electronic image stabilization on the first processing result according to a second rotation matrix.

The first rotation matrix may be determined according to an attitude-angle parameter of an observer, and the first processing result may be processed according to the first rotation matrix to obtain the second processing result.

The processor 12 may also be configured to obtain an attitude-angle parameter of the observer.

The second rotation matrix may be determined according to measurement parameters obtained from an inertial measurement unit connected to the camera. The processor 12 may be configured to obtain a second processing result by processing the first processing result according to the second rotation matrix.

In one embodiment, the processor 12 is used to obtain the measurement parameters from an inertial measurement unit connected to the camera, and the processor 12 is also used to determine the second rotation matrix according to the measurement parameters. In some other embodiments, the processor 12 may be configured to obtain the second rotation matrix from an inertial measurement unit connected to the camera, where the second rotation matrix is determined by the inertial measurement unit according to the measurement parameters.

The camera imaging model includes any one of a pinhole imaging model, an isometric rectangular model, a stereo imaging model, a fisheye lens model, or a wide-angle lens model.

The image processing apparatus provided by the present disclosure may be used to implement the technical solutions of the present disclosure.

It should be noted that division of modules in the present disclosure is schematic, and is only a type of division based on logical functions. In actual implementations, modules may be divided in other ways. In one embodiment, all functional modules may be integrated into an integrated processing module. In some other embodiments, each functional module may separately exist physically, or two or more functional modules may be integrated into one integrated processing module. The functional modules may be implemented in a form of hardware or software, and the integrated processing modules may also be implemented in a form of hardware or software.

When the integrated processing module is implemented in a form of software, and sold or used as an independent product, the integrated processing module may be stored in a non-transitory computer-readable storage medium. Based on this understanding, the technical solutions of the present disclosure essentially, or part of the technical solutions that contributes to existing technologies, or all or part of the technical solutions, may be embodied in a form of a software product. The software product may be stored in a storage medium. The software product may include several instructions, such that a computer device (may be a personal computer, a server, or a network device) or a processor may perform all or part of steps of the image processing method provided by the present disclosure. The storage medium may include any medium that may be used to store program codes, such as a U disk, a mobile hard disk, a ROM, a RAM, a magnetic disk, or an optical disk.

The embodiments of the present disclosure may be implemented in whole or in part by one or a combination of software, hardware, or firmware. When implemented by software, the embodiment may be implemented in whole or in part in a form of a computer program product. The computer program product may include one or more computer instructions. When the computer program instructions are loaded and executed on a computer, processes or functions according to the embodiment may be wholly or partially realized.

The computer may be a general-purpose computer, a special-purpose computer, a computer network, or another programmable device. The computer instructions may be stored in a non-transitory computer-readable storage medium, or may be transmitted from one non-transitory computer-readable storage medium to another non-transitory computer-readable storage medium. For example, the computer instructions may be transmitted from a website site, computer, server, or data center to another website site, computer, server, or data center via a wired approach (for example, coaxial cable, optical fiber, or digital subscriber line (DSL)) or a wireless approach (for example, infrared, wireless, microwave, etc.).

The non-transitory computer-readable storage medium may be any usable medium that may be accessed by a computer, or a data storage device such as a server, a data center, or the like that includes one usable medium or a plurality of usable media that are integrated. The usable medium may be a magnetic medium (for example, a floppy disk, a hard disk, a magnetic tape), an optical medium (for example, a DVD), or a semiconductor medium (for example, a Solid State Disk (SSD)).

In the present disclosure, division of the functional modules is exemplary, and is for a purpose of description convenience and brevity only. Those skilled in the art may understand that, functions in the present disclosure may be allocated to different functional modules according to practical applications. That is, an internal structure of an image processing apparatus provided by the present disclosure may be divided into different functional modules, such that all or part of the functions may be achieved. For specific working process of the apparatus, references may be made to processes of corresponding embodiments in the present disclosure, and details are not described herein again.

Accordingly, the technical solutions of the present disclosure may have the following advantages. The image processing method and apparatus provided by the present disclosure may obtain a first processing result by performing a two-dimension to three-dimension conversion operation on two-dimensional coordinate points of an acquired input image. A second processing result may be obtained by processing the first processing result, according to at least one of a first rotation matrix or a second rotation matrix. The second processing result may be mapped to a two-dimensional image coordinate system, and an output image may thus be obtained. Accordingly, rapid processing of the input image may be realized, such that at least two operations of distortion correction, virtual reality processing and electronic image stabilization may be completed. As such, calculation complexity may be reduced, calculation time may be shortened, and image processing efficiency may be improved.

Finally, it should be noted that the above embodiments are only used to illustrate the technical solutions of the present disclosure, but do not limit the present disclosure. Although the present invention has been described in detail with reference to the foregoing embodiments, those skilled in the art should understand that the technical solutions described in the foregoing embodiments may still be modified, or some or all of the technical features may be equivalently replaced. These modifications or replacements do not deviate the essence of the corresponding technical solutions from the scope of the technical solutions of the present disclosure.

What is claimed is:

1. An image processing method, comprising:
obtaining two-dimensional coordinate points of an input image;
according to a camera imaging model or a distortion correction model, performing a two-dimension to three-dimension conversion operation on the two-dimensional coordinate points to obtain a first processing result;
performing at least one of virtual reality processing or electronic image stabilization on the first processing result to obtain a second processing result; and
mapping the second processing result to a two-dimensional image coordinate system to obtain an output image.

2. The method according to claim 1, wherein the performing the two-dimension to three-dimension conversion operation on the two-dimensional coordinate points to obtain the first processing result further includes:
according to camera parameters and the distortion correction model, performing the two-dimension to three-dimension conversion operation on the two-dimensional coordinate points to obtain the first processing result; or
according to the camera parameters and the camera imaging model, performing the two-dimension to three-dimension conversion operation on the two-dimensional coordinate points to obtain the first processing result.

3. The method according to claim 1, wherein the virtual reality processing is performed on the first processing result according to a first rotation matrix.

4. The method according to claim 2, wherein the electronic image stabilization is performed on the first processing result according to a second rotation matrix.

5. The method according to claim 3, wherein:
the first rotation matrix is determined according to an attitude-angle parameter of an observer; and
according to the first rotation matrix, the first processing result is processed to obtain the second processing result.

6. The method according to claim 5, further comprising:
obtaining the attitude-angle parameter of the observer.

7. The method according to claim 4, wherein:
the second rotation matrix is determined according to measurement parameters obtained from an inertial measurement unit connected to a camera; and
the first processing result is processed to obtain the second processing result according to the second rotation matrix.

8. The method according to claim 7, further comprising:
obtaining the measurement parameters from the inertial measurement unit connected to the camera, and determining the second rotation matrix according to the measurement parameters; or
obtaining the second rotation matrix from the inertial measurement unit connected to the camera, wherein the second rotation matrix is determined by the inertial measurement unit according to the measurement parameters.

9. The method according to claim 2, wherein the camera imaging model includes any one of a pinhole imaging model, an isometric rectangular model, a stereo imaging model, a fisheye lens model, or a wide-angle lens model.

10. An image processing apparatus, comprising:
a lens, an image sensor, and a processor, wherein:
the image sensor acquires a two-dimensional image through the lens, and the two-dimensional image is used as an input image; and
the processor is configured to perform:
obtaining two-dimensional coordinate points of the input image;
according to a camera imaging model or a distortion correction model, performing a two-dimension to three-dimension conversion operation on the two-dimensional coordinate points to obtain a first processing result;
performing at least one of virtual reality processing or electronic image stabilization on the first processing result to obtain a second processing result; and
mapping the second processing result to a two-dimensional image coordinate system to obtain an output image.

11. The apparatus according to claim 10, wherein the performing the two-dimension to three-dimension conversion operation on the two-dimensional coordinate points to obtain the first processing result further includes:
according to camera parameters and the distortion correction model, performing the two-dimension to three-dimension conversion operation on the two-dimensional coordinate points to obtain the first processing result; or
according to the camera parameters and the camera imaging model, performing the two-dimension to three-dimension conversion operation on the two-dimensional coordinate points to obtain the first processing result.

12. The apparatus according to claim 10, wherein the virtual reality processing is performed on the first processing result according to a first rotation matrix.

13. The apparatus according to claim 11, wherein the electronic image stabilization is performed on the first processing result according to a second rotation matrix.

14. The apparatus according to claim 12, wherein:
the first rotation matrix is determined according to an attitude-angle parameter of an observer; and
according to the first rotation matrix, the first processing result is processed to obtain the second processing result.

15. A non-transitory computer-readable storage medium containing computer-executable instructions for, when executed by one or more processors, performing an image processing method, the method comprising:
obtaining two-dimensional coordinate points of an input image;
according to a camera imaging model or a distortion correction model, performing a two-dimension to three-dimension conversion operation on the two-dimensional coordinate points to obtain a first processing result;
performing at least one of virtual reality processing or electronic image stabilization on the first processing result to obtain a second processing result; and
mapping the second processing result to a two-dimensional image coordinate system to obtain an output image.

16. The storage medium according to claim 15, wherein the performing the two-dimension to three-dimension conversion operation on the two-dimensional coordinate points to obtain the first processing result further includes:
according to camera parameters and the distortion correction model, performing the two-dimension to three-dimension conversion operation on the two-dimensional coordinate points to obtain the first processing result; or
according to the camera parameters and the camera imaging model, performing the two-dimension to three-dimension conversion operation on the two-dimensional coordinate points to obtain the first processing result.

17. The storage medium according to claim 15, wherein the virtual reality processing is performed on the first processing result according to a first rotation matrix.

18. The storage medium according to claim 16, wherein the electronic image stabilization is performed on the first processing result according to a second rotation matrix.

19. The storage medium according to claim 17, wherein:
the first rotation matrix is determined according to an attitude-angle parameter of an observer; and
according to the first rotation matrix, the first processing result is processed to obtain the second processing result.
